(19) United States
(12) Patent Application Publication
(10) Pub. No.: US 2022/0410175 A1
(43) Pub. Date: Dec. 29, 2022

(54) RELEASE AGENT FOR IMPROVED REMOVAL OF VALUABLE MATERIAL FROM THE SURFACE OF AN ENGINEERED COLLECTION MEDIA

(71) Applicants: CiDRA Corporate Services LLC, Wallingford, CT (US); BYK-Chemie GmbH, Wesel (DE)

(72) Inventors: Guillaume JAUNKY, Wesel (DE); Wolfgang GRIESEL, Hamminkeln (DE); Allison GREENE, West Hartford, CT (US); Michael D. COPPOLA, Trumbull, CT (US); Kevin LASSILA, Bethany, CT (US); Michael RYAN, Newtown, CT (US); Paul DOLAN, Portland, CT (US); Mark R. FERNALD, Enfield, CT (US); Paul J. ROTHMAN, Windsor, CT (US)

(21) Appl. No.: 17/780,196

(22) PCT Filed: Dec. 11, 2020
(86) PCT No.: PCT/US2020/064496

§ 371 Date: May 26, 2022

Related U.S. Application Data
(60) Provisional application No. 62/947,617, filed on Dec. 13, 2019.

(51) Int. Cl. B03D 1/08; B03D 1/02

(52) U.S. Cl. CPC B03D 1/082; B03D 1/023; B03D 2201/02

(57) ABSTRACT

An apparatus for removing mineral particles from loaded engineered collection media includes one or more solvents with sufficiently low surface tension. The engineered collection media are made of a synthetic material and have a surface coated with a hydrophobic material to provide a chemical bond between the mineral particles and the surface. The solvents together with a releasing mechanism are arranged to disrupt the chemical bond. Preferably, a surfactant or a nonionic surfactant is also added to the solvents.

### CROSS REFERENCE TO RELATED APPLICATION

This application claims the benefit of U.S. Provisional Application No. 62/947,617 (712-2.466 (CCS-0215)), filed on 13 Dec. 2019, which is incorporated by reference herein in its entirety.

### BACKGROUND OF THE INVENTION

### 1. Technical Field

This invention relates generally to techniques for separating valuable material from unwanted material in a mixture, such as a pulp slurry; and more particularly, relates to a method and apparatus for separating valuable material from unwanted material in a mixture, such as a pulp slurry, e.g., using an engineered collection media.

More particularly, this invention relates to an improved method for the removal of valuable material from said engineered collection media through the use of solvents with sufficiently low surface tension.

### 2. Description of Related Art

In many industrial processes, flotation is used to separate valuable or desired material from unwanted material. By way of example, in this process a mixture of water, valuable material, unwanted material, chemicals and air is placed into a flotation cell. The chemicals are used to make the desired material hydrophobic and the air is used to carry the material to the surface of the flotation cell. When the hydrophobic material and the air bubbles collide, they become attached to each other. The bubble rises to the surface carrying the desired material with it.

The performance of the flotation cell is dependent on the air bubble surface area flux and air bubble size distribution in the collection zone of the cell. The air bubble surface area flux is dependent on the size of the bubbles and the air injection rate. Controlling the air bubble surface area flux has traditionally been very difficult. There is a need in the industry to provide a better way to separate valuable material from unwanted material, e.g., including in such a flotation cell, so as to eliminate problems associated with using air bubbles in such a separation process.

By way of example, WO2018183244A1, WO2018085490A1, WO2018160793A1, EP3377230A1 disclose processes whereby a crushed mineral ore in an aqueous slurry is treated with a collector, a chemical which adsorbs selectively onto particles containing the mineral of interest, rendering these particles hydrophobic or partially hydrophobic. This treated slurry is then exposed to an engineered collection media with a hydrophobic surface, generally comprised of a silicone or hydrocarbon-containing polymer, and the hydrophobic or partially hydrophobic particles are selectively adsorbed onto the surface of the media. The particle-containing media is then separated from the slurry and treated with a release agent whereupon the particles containing the valuable material released from the surface of the media and isolated.

Moreover, U.S. Pat. No. 9,731,221, entitled “Apparatus having polymer surfaces having a siloxane functional group,” discloses the use of one or more of a combination of mechanisms to release mineral particles collected on the surface of an engineered collection medium, such as acoustic, mechanical, thermal and/or chemical action. Additionally, PCT Publication Number WO2017066756 A1, entitled “Opportunities for recovery augmentation process as applied to molybdenum production”; PCT Publication Number WO2017066752 A1, entitled “Mineral beneficiation utilizing engineered materials for mineral separation and coarse particle recovery”; PCT Publication Number WO2017087498 A1, entitled “Utilizing engineered media for recovery of minerals in tailings stream at the end of a flotation separation process”; PCT Publication Number WO 2017117200, entitled “Tumbler cell for mineral recovery using engineered media”; and PCT Publication Number WO 2017120569 A1, entitled “Open cell or reticulated foam functionalized open-network structure for selective separation of mineral particles in an aqueous system,” each discloses the use of one or more of a combination of methods for release of material from an engineered collection media, including, but not limited to, acoustic, mechanical, thermal and/or chemical action.

### SUMMARY OF THE INVENTION

The present invention uses solvents with sufficiently low surface tension together with releasing mechanisms to remove mineral particles from loaded engineered collection media. A surfactant may also be used to assist the removal process.

According to some embodiments, the present invention may include, or take the form of, an apparatus, comprising:

a body having an upper portion and a lower portion;

a first input configured to receive loaded engineering media;

a second input configured to receive a releasing agent;

a first output located on the upper portion configured to discharge recovered engineering media; and

a second output located on the lower portion configured to discharge a concentrate, wherein the loaded engineered media comprise engineered media, each of the engineered media made of a synthetic material having a surface functionalized to attract mineral particles to the surface, and the releasing agent is arranged to remove the mineral particles from the surface to provide the recovered engineering media, and the concentrate comprises the mineral particles, and wherein the releasing agent comprises a chemical solvent and a surfactant.

The apparatus may also include one or more of the following features:

The chemical solvent may be selected from the group consisting of hexane, decamethylcyclopentasiloxane, isopropyl alcohol, methyl ethyl ketone, cyclohexane, tetrahydrofuran, i-nonyl alcohol, i-decyl alcohol, 2-butoxy ethanol and toluene, or a combination thereof.

The loaded engineering media may be mixed with an aqueous solution in the body.

The loaded engineering media may be mixed with an aqueous solution in the body, and wherein the surfactant comprises a nonionic surfactant in the aqueous solution, the nonionic surfactant selected from alkoxylated alcohols, Guerbet alcohols and their alkoxylates, glycol ethers, copolymers of polyethylene glycol and polypropylene glycol and acetylenic diols and their alkoxylates, and polyethe modified-silicones.

The surface of the engineered media may include a plurality of molecules to provide a chemical bond between the mineral particles and the surface, said apparatus further comprising:

a releasing mechanism arranged to provide a force to disrupt the chemical bond between the mineral particles and the surface.

The releasing mechanism may be selected from a stirrer, a sonic source, a heat source, and a light beam.

The surface may be a coating for providing the molecules, and the coating is made of a hydrophobic material selected from poly(dimethylsiloxane), polysiloxanates and fluoroalkylsilane.

The synthetic material may include a polymer-based material, silica-based material or ceramic-based material.

The engineered media may include synthetic beads having the surface, and wherein the synthetic beads are made of a material having a density smaller than density of water.

The surface of the engineered media may include a three-dimensional open-cell structure, and the engineered media is made of a material selected from the group consisting of polyester urethanes, polyether urethanes, reinforced urethanes, composites like PVC coated PU, carbon fiber foams and hard plastics.

The engineered media may include one or more moving conveyor belts having the surface and the releasing mechanism comprises a brush arranged to contact the surface to provide the force to disrupt the chemical bond.

### The Method

According to some embodiments, the present invention may take the form of a method for processing loaded engineering media, the loaded engineered media may include engineered media, each of the engineered media made of a synthetic material having a surface functionalized to attract mineral particles to the surface, said method including steps for:

providing a releasing agent in a container;

causing the loaded engineered media to contact the releasing agent; and

allowing the releasing agent to remove the mineral particles from the surface, wherein the releasing agent comprises a surfactant and a chemical solvent.

The method may also include one or more of the following features:

The chemical solvent may be selected from the group consisting of hexane, decamethylcyclopentasiloxane, isopropyl alcohol, methyl ethyl ketone, cyclohexane, tetrahydrofuran, i-nonyl alcohol, i-decyl alcohol, 2-butoxy ethanol and toluene, or a combination thereof.

The container may include an aqueous solution mixed with the loaded engineering media.

The container may include an aqueous solution mixed with the loaded engineering media, and wherein the surfactant comprises a nonionic surfactant in the aqueous solution, the nonionic surfactant selected from alkoxylated alcohols, Guerbet alcohols and their alkoxylates, glycol ethers, copolymers of polyethylene glycol and polypropylene glycol and acetylenic diols and their alkoxylates, and polyether modified-silicones.

The surface of the engineered media may include a plurality of molecules to provide a chemical bond between the mineral particles and the surface, said method further comprising arranging a releasing mechanism to provide a force to disrupt the chemical bond between the mineral particles and the surface.

The releasing mechanism may include a stirrer, a sonic source, a heat source or a light beam.

The container may include a top end and a bottom end, said method further including:

separating the mineral particles from the engineered media;

discharging the mineral particles from the bottom end of the container; and

discharging the engineered media from the top end of the container.

The synthetic material may include a polymer-based material, silica-based material or ceramic-based material, and the surface may include a coating for providing the molecules, and the coating may be made of a hydrophobic material selected from poly(dimethylsiloxane), polysiloxanates and fluoroalkylsilane.

The surface of the engineered media may include a three-dimensional open-cell structure, and the engineered media may be made of a material selected from the group consisting of polyester urethanes, polyether urethanes, reinforced urethanes, composites like PVC coated PU, carbon fiber foams and hard plastics.

The engineered media may include one or more moving conveyor belts having the surface, and the releasing mechanism may include a brush arranged to contact the surface to provide the force to disrupt the chemical bond.

### BRIEF DESCRIPTION OF THE DRAWING

The drawing includes FIGS. 1-6, which are briefly described as follows:

FIG. 1 is a schematic presentation of an apparatus for the removal of the valuable material from the engineered media, according to some embodiments of the present invention.

FIG. 2 shows the apparatus wherein a mechanical device is used to assist the removal of the valuable material from the engineered media, according to some embodiments of the present invention.

FIG. 3 shows the apparatus wherein a sonic device is used to assist the removal of the valuable material from the engineered media, according to some embodiments of the present invention.

FIG. 4 shows the apparatus wherein a heat source or a light source is used to assist the removal of the valuable material from the engineered media, according to some embodiments of the present invention.

FIG. 5 shows the effectiveness of various solvents in removing the valuable material from the engineered media, according to some embodiments of the present invention.

FIG. 6 shows the apparatus wherein a conveyor belt is an engineered collection medium, according to some embodiments of the present invention.

### DETAILED DESCRIPTION OF THE INVENTION

One important feature of the present invention relates to the removal of the valuable material from the surface of the engineered media. The removal of the valuable material is effected by exposing the particle-laden media to a liquid release agent, in combination with some type of mechanical agitation. This results in the release of the particles from the surface of the engineered media into the release agent, whereupon the particles can be isolated through a process such as filtration or centrifugation, etc. At the outset of this work, little was known about the characteristics of an effective release agent.

In an aqueous solution, it may be desirable to utilize a chemical action for release of material from an engineered collection media by lowering the surface tension of the solution through the use of a solvent or surfactant as disclosed herein. However, it may be desirable to improve the action of such release to provide the following properties:
1. Rapid material liberation from the media surface;
2. Reduction in the mechanical forces necessary to liberate the material from the media surface reducing the potential for mechanical damage to the media surface;
3. Reduction of the organic content of the release solution to minimize the potential for environmental impact; and
4. Reduction of damage to the media surface through interaction with the release agent.

While the use of a surfactant or solvent to lower surface tension in an aqueous solution for release of material from an engineered collection media has been found effective, the effectiveness may be improved by a combination or blend of materials to (i) rapidly lower the surface tension of the solution through the action of one material, such as an organic solvent; and (ii) maximize the surface tension reduction through the action of a second material, such as a surfactant.

By way of example, a rapid reduction in surface tension of an aqueous solution for separation of material from an engineered collection media can be achieved by the addition of an organic solvent to the solution. Further reduction in surface tension and maintenance of low surface tension can be achieved by the addition of a surfactant to the solution.

Low surface tension release agents provide rapid wetting of the engineered collection media, which is comprised of a low surface energy material. This fast dynamic wetting of the collection media surface effectively liberates any adhered material from the surface. The material removal efficiency of the release agent increases with decreasing dynamic surface tensions. Experiments have shown that the release agent should have a dynamic surface tension less than 45 dynes at 10 ms to effectively release material from an engineered collection media. Optimal performance is observed with a dynamic surface tension less than 35 dynes at 10 ms.

The release agent should perform and be chemically stable independent of ambient conditions, across broad temperature (0-50° C.) and at various pH (2-12). The release agent used in combination with mechanical forces can increase removal efficiency of the material from the engineered collection media. The release agent should not adversely affect the collection media, as the collection media will be reused after exposure to the release agent. Removal of the release agent from the collection media surface is desired. Removal and recovery of the release agent from the collection media is desirable and can be influenced by solubility in water or solvent.

The release agent may be comprised of these classes of materials:

Nonionic surfactants
Alkoxylated alcohols
Acetylenic diols
Glycol ethers
Silicone
Guerbet alcohol
Alcohols

Organic Solvents

The solution can be comprised of pure organic solvents or organic solvent blends, or preferably, an aqueous solution of an organic co-solvent, or more preferably, an aqueous solution of an organic co-solvent containing a surfactant. In the preferred embodiments of the invention, the solution exhibits static and dynamic surface tensions sufficiently low to provide the wetting necessary to effectively remove the material from the media.

### The Engineered Collection Media

The engineered collection media, or engineered media, as used in the present invention are synthetic beads having a surface coated with a hydrophobic material, chosen to attract mineral particles in an aqueous slurry. The engineered media having mineral particles attached thereto are referred to as loaded collection media. Synthetic beads can be made of a polymer-based material, silica-based material (such as glass) or a ceramic-based material. The surface coating of the synthetic beads can be made of poly(dimethylsiloxane), polysiloxanates or fluoroalkylsilane. The density of the synthetic beans can be greater, smaller than, or equal to the density of the slurry. In a flotation cell, it is advantageous to use synthetic beads having a density smaller than the density of the slurry. As such, the loaded engineered media can move upward to allow the attached mineral particles to be removed from the media surface. After the mineral particles are removed, the “stripped” engineered media can be skimmed off from the flotation cell to be used as “recovered” engineered media.

The surface of the engineered media can be porous and the engineered media can be made of a reticulated foam having a three-dimensional open-cell structure. By way of example, the open cell foam may be made from a material or materials selected from a group that includes polyester urethanes, polyether urethanes, reinforced urethanes, composites like PVC coated PU, non-urethanes, as well as metal, ceramic, and carbon fiber foams and hard, porous plastics, in order to enhance mechanical durability.

The engineered collection media can be configured differently from synthetic beads. For example, a conveyor belt coated with a hydrophobic material such as poly(dimethylsiloxane), polysiloxanates or fluoroalkylsilane can also be used to collect mineral particles in an aqueous slurry. Conveyor belts having mineral particles attached thereto, or loaded conveyor belts, are also loaded engineered media. The present invention can also be used for the removal of mineral particles from the loaded conveyor belts.

Filters coated with a hydrophobic material such as poly(dimethylsiloxane), polysiloxanates or fluoroalkylsilane can also be used to collect mineral particles in an aqueous slurry. Filters having mineral particles attached thereto, or loaded filters, are also loaded engineered media. The present invention can also be used for the removal of mineral particles from the loaded filters.

### Polymer-Based Synthetic Materials

The synthetic material may be selected from a group consisting of polyamides, polyesters, polyurethanes, phenol-formaldehyde, urea-formaldehyde, melamine-formaldehyde, polyacetal, polyethylene, polyisobutylene, polyacrylonitrile, poly(vinyl chloride), polystyrene, poly(methyl methacrylates), poly(vinyl acetate), poly(vinylidene chloride), polyisoprene, polybutadiene, polyacrylates, poly(carbonate), phenolic resin, and polydimethylsiloxane.

### The Flotation Cell

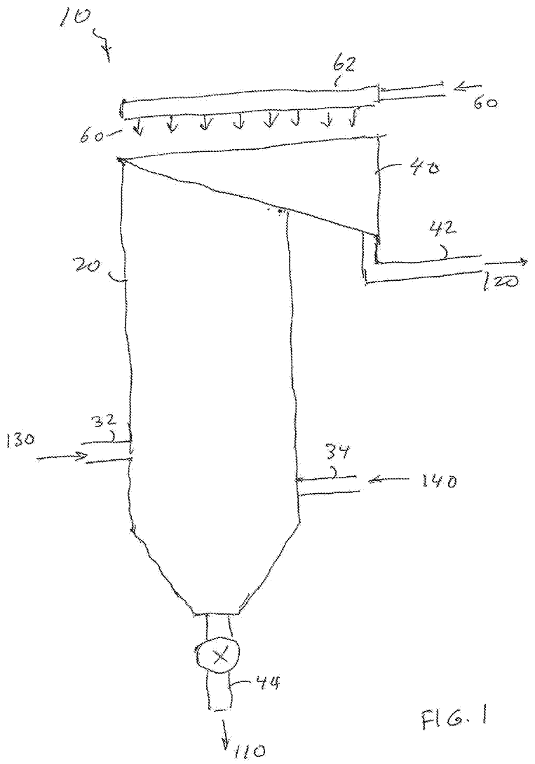

The present invention can be carried out in various containers and reactors. According to some embodiments of the present invention, a flotation tank or cell may be used for the removal of the valuable material, or the mineral particles, from the loaded engineered media. As shown in FIG. 1, the flotation cell or tank 10 may include a cell body 20. To be effective in the collection of the mineral particles, the engineered media may be chosen to have a density smaller than the slurry mixture in the cell body 20. According to some embodiments of the present invention, the flotation cell 10 may include an input 32 located in the lower portion of the cell body 20 configured to receive the loaded engineered media 130. Another input 34 may be configured to receive a release agent 140. On the bottom of the cell body 20, an output 44 may be used to discharge mineral particles as concentrate 110. After the loaded engineered media are stripped off of mineral particles, the engineered media float to the top of the cell body 20 to be washed by water 60 from a water spray 62 and collected in a collection area 40. An output 42 may be provided to discharge the “recovered” engineered media 120 for reuse, if so desired.

According to some embodiments of the present invention, the releasing agent may be selected from the group consisting of hexane, decamethylcyclopentasiloxane, isopropyl alcohol, methyl ethyl ketone, cyclohexane, tetrahydrofuran, i-nonyl alcohol, i-decyl alcohol, 2-butoxy ethanol and toluene.

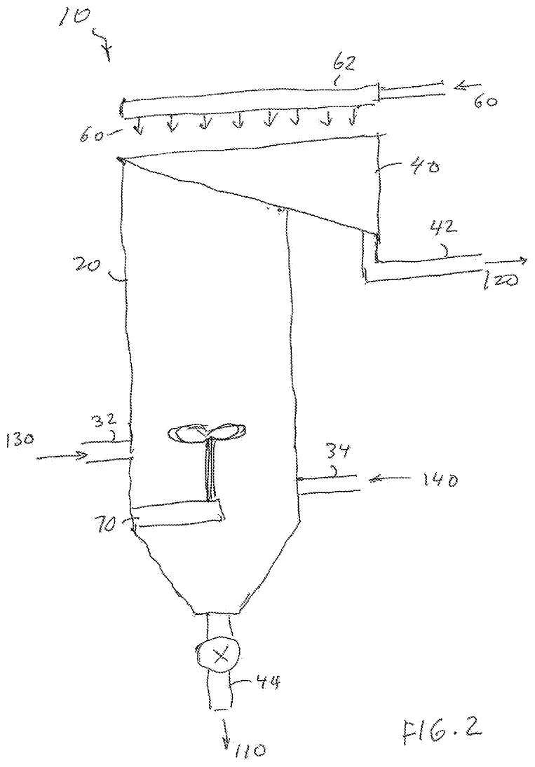

As the surface of the engineered media has a plurality of molecules to provide a chemical bond between the mineral particles and the surface, a releasing mechanism can be arranged to provide a force to disrupt the chemical bond between the mineral particles and the surface. FIGS. 2-4 show such a releasing mechanism.

In FIG. 2, a mechanical agitator, such as a stirrer 70, may be used to provide the force to disrupt the chemical bond.

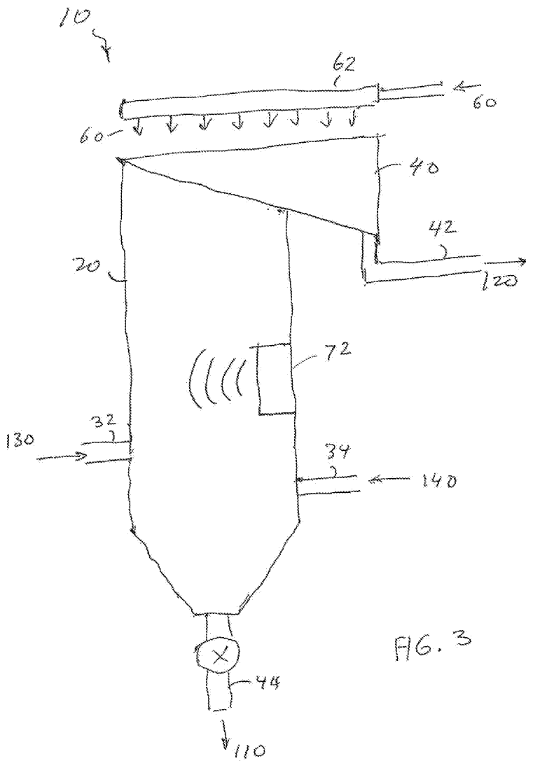

In FIG. 3, a sonic device 72 may be used to produce ultrasound waves as a force to disrupt the chemical bond.

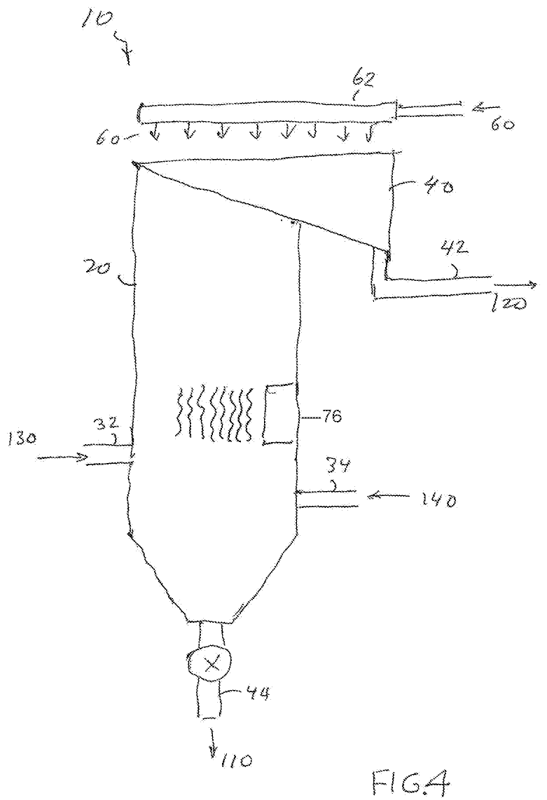

In FIG. 4, heat or light may be used as a force to disrupt the chemical bond. As shown, the device 76 can be a heat source or a laser.

According to some embodiments of the present invention, a surfactant may be also contained in the cell body 40 to assist the removal of the mineral particles from the loaded engineered media.

According to some embodiments of the present invention, a nonionic surface may be also contained in the cell body 40 to assist the removal of the mineral particles from the loaded engineered media. The nonionic surfactant may be selected from alkoxylated alcohols, acetylenic diols, glycol ethers, silicone and guerbet alcohol.

In experimentation, it has been found that a high concentration of a solvent, such as an organic co-solvent will rapidly lower the surface tension of an aqueous solution containing an engineered collation media having material of interest attached. However, the high concentration solvent may degrade the integrity of the media.

By combining a very low concentration of surfactant to a solvent solution, the amount of solvent can be significantly reduced, by more than a factor of 10, while achieving improved results in the release of material collected on the surface of the media. The solvent rapidly reduces the surface tension, while the surfactant provides an overall lower surface tension of the solution.

Numerous benefits can be realized by utilizing a release agent comprised of a low concentration of surfactant combined with a low concentration of solvent for removal of mineral particles from the surface of an engineered collection media, including:
Rapid liberation of material from the media surface;
Reduction in the mechanical forces necessary to liberate the material from the media surface;
Reduction in the breakdown of the media through chemical action; and
Reduced potential for environmental impact.

A number of experiments have been carried out to show that the surface tension of the release agent is critical to effectively removing the particles from the surface of the media. Specifically, the surface tension of the release agent must be sufficiently low.

Experiments labeled as Examples 1-17 have been carried out. In these examples, the experimental ingredients are as follows:

Water (100 mL) was measured into a glass jar and 0.08 g of chalcopyrite powder (particle size=140 micron) was added to the jar. 0.6 mL 8989 alkyl xanthate promoter (1000:1 dilution) was added to the jar and the jar was hand mixed for 2 minutes. Twelve QGEL 314 coated beads (supplied by CiDRA) were added to the jar and the contents were hand mixed for 4 minutes, during which time the chalcopyrite particles were adsorbed onto the surface of the media. At this point, the beads were removed and placed into small glass vials containing various solvents and agitated on a Fischer Scientific Touch Mixer for 5 minutes. The samples were then visually assessed for chalcopyrite removal efficiency using a scale of 1-4 (4=Best). The results summarized in the table below indicate that the adsorbed particles are readily removed when the release agent is comprised of solvents with a surface tension lower than about 30 dynes/cm. In some cases, solvents with higher surface tensions are able to effect some particle removal, but the ability to efficiently remove the particles is significantly compromised using the higher surface tension solvents.

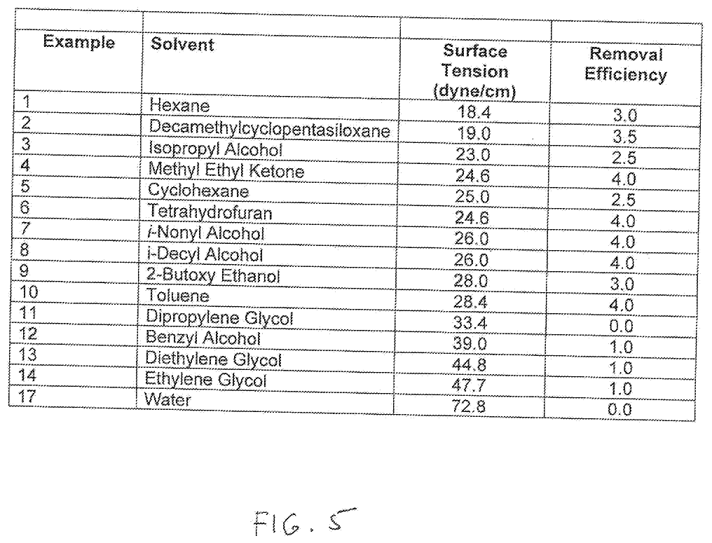

The experimental results of Examples 1-4 and 17 are shown in FIG. 5.

### Conveyor Belts

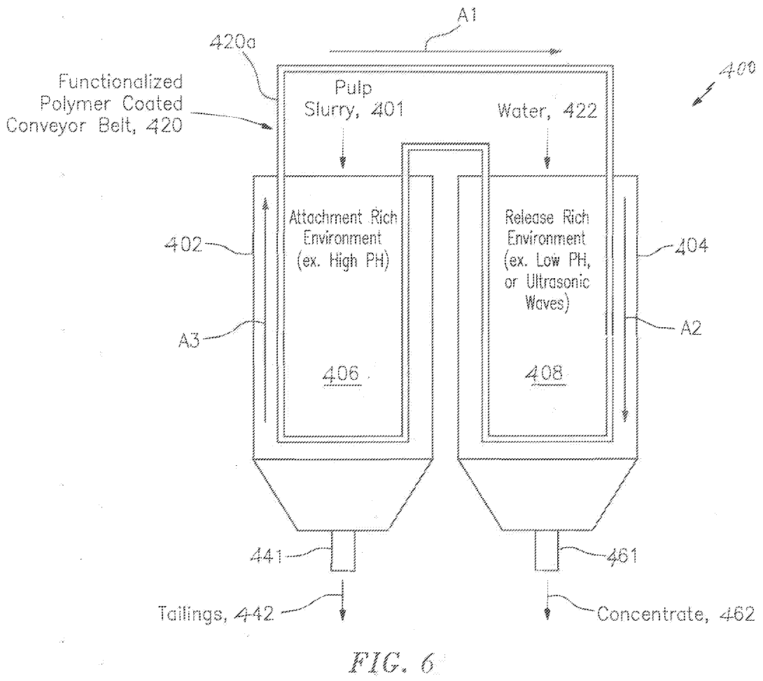

According to some embodiments of the present invention, the engineered media may take the form of one or more conveyor belts, e.g., such as a conveyor belt 420a as shown in FIG. 6. FIG. 6 shows a mineral processing system 400 including an attachment tank 402 and a releasing tank 404. The conveyor belt 420a is arranged to move in a loop between the attachment tank 402 and the releasing tank 404 in a direction indicated by arrows A1, A2 and A3. The conveyor belt 420a may be made of a flexible polymer such as polyurethane, coated with a hydrophobic material such as poly(dimethylsiloxane) or fluoroalkylsilane to attract the mineral particles in the pulp slurry 401. The processed slurry can be discharged as tailings 442 from an output 441. Reference numeral 406 in the attachment tank 402 denotes an attachment environment which is not part of the present invention. When part of the conveyor belt 420a leaves the attachment tank 402 and moves into the releasing tank 404, it is “loaded” with mineral particles. In the releasing tank 404, reference numeral 408 denotes a releasing rich environment wherein the aqueous solution containing water 442 and one or more solvents with sufficiently low surface tension is used to release the mineral particles from the loaded conveyor belt. In the releasing tank 404, a releasing mechanism such as stirrer or sound waves may be also used to assist the removal of mineral particles from the conveyor belt surface. Furthermore, a brush contacting the moving conveyor belt may also be used to scrape off the mineral particles. The released mineral particles are discharged through an output 461 as concentrate 462.

It should be appreciated that any of the features, characteristics, alternatives or modifications described regarding a particular embodiment herein may also be applied, used, or incorporated with any other embodiment described herein. The engineered collection media can be made from a magnetic polymer or have a magnetic core so that the para-, ferri-, ferro-magnetism of the engineered collection media is greater than the para-, ferri-, ferro-magnetism of the unwanted ground ore particles in the slurry. Thus, although the invention has been described and illustrated with respect to exemplary embodiments thereof, the foregoing and various other additions and omissions may be made therein and thereto without departing from the scope of the present invention.

What is claimed is:

1. An apparatus, comprising:
a body having an upper portion and a lower portion;
a first input configured to receive loaded engineering media;
a second input configured to receive a releasing agent;
a first output located on the upper portion configured to discharge recovered engineering media; and
a second output located on the lower portion configured to discharge a concentrate, wherein the loaded engineered media comprise engineered media, each of the engineered media made of a synthetic material having a surface functionalized to attract mineral particles to the surface, and the releasing agent is arranged to remove the mineral particles from the surface to provide the recovered engineering media, and the concentrate comprises the mineral particles, and wherein the releasing agent comprises a chemical solvent and a surfactant.

2. The apparatus according to claim 1, wherein the chemical solvent is selected from the group consisting of hexane, decamethylcyclopentasiloxane, isopropyl alcohol, methyl ethyl ketone, cyclohexane, tetrahydrofuran, i-nonyl alcohol, i-decyl alcohol, 2-butoxy ethanol and toluene, or a combination thereof.

3. The apparatus according to claim 1, wherein the loaded engineering media are mixed with an aqueous solution in the body.

4. The apparatus according to claim 1, wherein the surfactant comprises a nonionic surfactant in the aqueous solution, the nonionic surfactant selected from alkoxylated alcohols, Guerbet alcohols and their alkoxylates, glycol ethers, copolymers of polyethylene glycol and polypropylene glycol and acetylenic diols and their alkoxylates, and polyether modified-silicones.

5. The apparatus according to claim 1, wherein the surface of the engineered media has a plurality of molecules to provide a chemical bond between the mineral particles and the surface, said apparatus further comprising:
a releasing mechanism arranged to provide a force to disrupt the chemical bond between the mineral particles and the surface.

6. The apparatus according to claim 5, wherein the releasing mechanism is selected from a stirrer, a sonic source, a heat source, and a light beam.

7. The apparatus according to claim 5, wherein the surface has a coating for providing the molecules, and the coating is made of a hydrophobic material selected from poly(dimethylsiloxane), polysiloxanates and fluoroalkylsilane.

8. The apparatus according to claim 1, wherein the synthetic material comprises a polymer-based material, silica-based material or ceramic-based material.

9. The apparatus according to claim 1, wherein the engineered media comprise synthetic beads having the surface, and wherein the synthetic beads are made of a material having a density smaller than density of water.

10. The apparatus according to claim 1, wherein the surface of the engineered media comprises a three-dimensional open-cell structure, and the engineered media is made of a material selected from the group consisting of polyester urethanes, polyether urethanes, reinforced urethanes, composites like PVC coated PU, carbon fiber foams and hard plastics.

11. The apparatus according to claim 5, wherein the engineered media comprise one or more moving conveyor belts having the surface and the releasing mechanism comprises a brush arranged to contact the surface to provide the force to disrupt the chemical bond.

12. A method for processing loaded engineering media, the loaded engineered media comprising engineered media, each of the engineered media made of a synthetic material having a surface functionalized to attract mineral particles to the surface, said method comprising:
providing a releasing agent in a container;
causing the loaded engineered media to contact the releasing agent; and
allowing the releasing agent to remove the mineral particles from the surface, wherein the releasing agent comprises a surfactant and a chemical solvent.

13. The method according to claim 12, wherein the chemical solvent is selected from the group consisting of hexane, decamethylcyclopentasiloxane, isopropyl alcohol, methyl ethyl ketone, cyclohexane, tetrahydrofuran, i-nonyl alcohol, i-decyl alcohol, 2-butoxy ethanol and toluene, or a combination thereof.

14. The method according to claim 12, wherein the container comprises an aqueous solution mixed with the loaded engineering media.

15. The method according to claim 12, wherein the surfactant comprises a nonionic surfactant in the aqueous solution, the nonionic surfactant selected from alkoxylated alcohols, Guerbet alcohols and their alkoxylates, glycol ethers, copolymers of polyethylene glycol and polypropylene glycol and acetylenic diols and their alkoxylates, and polyether modified-silicones.

16. The method according to claim 12, wherein the surface of the engineered media has a plurality of molecules to provide a chemical bond between the mineral particles and the surface, said method further comprising:
arranging a releasing mechanism to provide a force to disrupt the chemical bond between the mineral particles and the surface, and wherein the releasing mechanism comprises a stirrer, a sonic source, a heat source or a light beam.

17. The method according to claim 12, wherein the container has a top end and a bottom end, said method further comprising:
separating the mineral particles from the engineered media;
discharging the mineral particles from the bottom end of the container; and
discharging the engineered media from the top end of the container.

18. The method according to claim 12, wherein the synthetic material comprises a polymer-based material, silica-based material or ceramic-based material, and wherein the surface has a coating for providing the molecules, and the coating is made of a hydrophobic material selected from poly(dimethylsiloxane), polysiloxanates and fluoroalkylsilane.

19. The method according to claim 12, wherein the surface of the engineered media comprises a three-dimensional open-cell structure, and the engineered media is made of a material selected from the group consisting of polyester urethanes, polyether urethanes, reinforced urethanes, composites like PVC coated PU, carbon fiber foams and hard plastics.

20. The method according to claim 16, wherein the engineered media comprises one or more moving conveyor belts having the surface, and the releasing mechanism comprises a brush arranged to contact the surface to provide the force to disrupt the chemical bond.
